(19) United States
(12) Patent Application Publication
(10) Pub. No.: US 2008/0173026 A1
(43) Pub. Date: Jul. 24, 2008

(54) Regenerative cryocooler, cylinder used for the regenerative cryocooler, cryopump, recondensing apparatus, superconducting magnet apparatus, and semiconductor detecting apparatus

(75) Inventors: Hisae MITA, Tokyo (JP); Mingyao XU, Tokorozawa (JP)

Correspondence Address: RADER FISHMAN & GRAUER PLLC, LION BUILDING, 1233 20TH STREET N.W., SUITE 501, WASHINGTON, DC, 20036, US

(73) Assignee: SUMITOMO HEAVY INDUSTRIES, LTD., Tokyo (JP)

(21) Appl. No.: 11/892,873

(22) Filed: Aug. 28, 2007

(30) Foreign Application Priority Data
Sep. 1, 2006 (JP) 2006-237928

(51) Int. Cl. F25B 9/00; F25B 19/00; B01D 8/00; F17C 5/02; H01F 1/00

(52) U.S. Cl. 62/6; 62/51.1; 62/55.5; 62/47.1; 335/216

(57) ABSTRACT

A cylinder used for a cold head of a regenerative cryocooler, the cylinder includes an inside having a hollow-shaped configuration for a regenerative material, wherein the thickness of the cylinder at a high temperature end is greater than the thickness of the cylinder at a low temperature end.

### BACKGROUND OF THE INVENTION

1. Field of the Invention

The present invention generally relates to regenerative cryocoolers, cylinders used for the regenerative cryocoolers, cryopumps, recondensing apparatuses, superconducting magnet apparatuses, and semiconductor detecting apparatuses.

More specifically, the present invention generally relates to a regenerative cryocooler, a cylinder, such as a regenerator tube or a pulse tube, used for the regenerative cryocooler, and, a cryopump, a recondensing apparatus, superconducting magnet apparatus, and a semiconductor detecting apparatus using the regenerative cryocooler.

2. Description of the Related Art

Regenerative cryocoolers form cryogenic temperatures of approximately 4 K through approximately 100 K and are used for cooling superconducting magnets or for cryopumps. The regenerative cryocooler includes a compressing part, an expanding part, and a heat exchanging part.

The compressing part is configured to provide work from outside, compress working fluid, and remove compression heat so as to decrease entropy. The expanding part is configured to absorb the work (energy) from the compressed working fluid, expand the working fluid, and add heat from outside of a system so as to increase the entropy. The heat exchanging part is configured to separate the compressing part and the expanding part from the view point of temperature by using a regenerator and simultaneously to cause the flowing out of the entropy increased at the expanding part to the compressing part. A pulse tube cryocooler, a GM (Gifford-McMahon) cryocooler, a Stirling cryocooler, and others are examples of the regenerative cryocooler.

In the pulse tube cryocooler, an operation where working gas as working fluid compressed by a gas compressor flows in the regenerator and the pulse tube and an operation where the working fluid is received by the gas compressor and flows out from the regenerator or the pulse tube are repeated.

As a result of this, a cooling effect is formed at low temperature ends of the regenerator or the pulse tube. When the low temperature ends come in thermal contact with a subject, heat is removed from the subject.

The regenerator includes a cylinder filled with a regenerative material. The pulse tube includes empty cylinder. One end of these cylinders is a high temperature end and another end of these cylinders is a low temperature end.

In order to prevent heat being conducted from the high temperature end, the cylinder is made of thin-wall stainless steel. As the amount of heat entering from the high temperature end is larger, the cooling capacity is degraded more so that the temperature of the low temperature end is increased. Therefore, it is recommended that the thickness of the cylinder should be progressively reduced to be equal to or less than 1 mm.

On the other hand, as the cylinder is thinner, the cylinder is stretched in an axial direction by repeated compression and expansion of the working gas, which generates vibration at the low temperature end. If such vibration is transmitted to the cooling subject, the yield rate may be degraded in a semiconductor manufacturing apparatus requiring positioning with high precision.

FIG. 1 is a cross-sectional view of a related art pulse tube cryocooler. As shown in FIG. 1, a pulse tube cryocooler 500 has been suggested. See Japanese Laid-Open Patent Application Publication No. 2004-93062.

In the pulse tune cryocooler 500 shown in FIG. 1, pulse tubes 501 and 502 and regenerators 503 and 504 are made of thin-wall metal materials. Thick-wall parts 501a through 504a are formed in parts of the cylinders of them so that reinforcing regions are formed.

Furthermore, Japanese Laid-Open Patent Application Publication No. 2003-329324 discloses a technique where the low temperature end of the cylinder is made thicker than the high temperature end of the cylinder so that vibration is reduced.

However, in the technique discussed in Japanese Laid-Open Patent Application Publication No. 2004-93062, although vibration is made in a direction where the vibration is reduced by the thick-wall parts 501a through 504a, this is not sufficient. Furthermore, if a large number of the thick-wall parts 501a through 504a are provided in order to reduce the vibration, degradation of cooling capacity may be caused.

In addition, in the technique discussed in Japanese Laid-Open Patent Application Publication No. 2003-329324, while a vibration prevention effect may be expected, the cooling capability may be degraded.

### SUMMARY OF THE INVENTION

Accordingly, embodiments of the present invention may provide a novel and useful regenerative cryocooler, cylinder used for the regenerative cryocooler, cryopump, recondensing apparatus, superconducting magnet apparatus, and semiconductor detecting apparatus, solving one or more of the problems discussed above.

More specifically, the embodiments of the present invention may provide a regenerative cryocooler, a cylinder, such as a regenerator tube or a pulse tube used for the regenerative cryocooler, and, a cryopump, a recondensing apparatus, a superconducting magnet apparatus, and a semiconductor detecting apparatus using the regenerative cryocooler, whereby both good cooling capabilities and prevention of vibration can be achieved.

One aspect of the present invention may be to provide a cylinder used for a cold head of a regenerative cryocooler, the cylinder including:

an inside having a hollow-shaped configuration for a regenerative material,

wherein the thickness of the cylinder at a high temperature end is greater than the thickness of the cylinder at a low temperature end

Another aspect of the present invention may be provide a regenerative cryocooler, including:

a working gas compressor;

a cold head configured to intake and exhaust a working gas;

wherein the regenerative cryocooler is a pulse tube cryocooler including
a regenerator tube having a regenerative material;
a hollow pulse tube where the low temperature end of the regenerator tube is connected; and
a cooling stage coming in contact with the low temperature end of the regenerator tube or the pulse tube; and

at least one of the regenerator tube and the pulse tube includes the cylinder mentioned above.

Other aspect of the present invention may be provide a regenerative cryocooler, including:

a working gas compressor;

a cold head configured to intake and exhaust a working gas;

wherein the regenerative cryocooler is a GM (Gifford-McMahon) type cryocooler including
a cylinder;
a displacer installed in the cylinder;
a regenerative material filling in the displacer;
a cooling stage coming in contact with the low temperature end of the cylinder; and

the cylinder is the cylinder mentioned above.

Other aspect of the present invention may be provide a regenerative cryocooler, including:

a working gas compressor;

a cold head configured to intake and exhaust a working gas;

wherein the regenerative cryocooler is a Stirling cryocooler including
a cylinder;
a displacer installed in the cylinder;
a regenerative material filling in the displacer;
a cooling stage coming in contact with the low temperature end of the cylinder; and

the cylinder is the cylinder mentioned above.

Other aspect of the present invention may be provide a cryopump, including:

a cryopanel configured to condense a gas molecule; and

the regenerative cryocooler mentioned above;

wherein the cryopanel is thermally and mechanically connected to the cooling stage of the regenerative cryocooler.

Other aspect of the present invention may be provide a recondensing apparatus, including:

a recondensing device configured to condense gas to liquid; and

the regenerative cryocooler mentioned above;

wherein the recondensing device is thermally and mechanically connected to the cooling stage of the regenerative cryocooler.

Other aspect of the present invention may be provide a superconducting magnet apparatus, including:

a superconducting magnet; and

the regenerative cryocooler mentioned above;

wherein the superconducting magnet is thermally and mechanically connected to the cooling stage of the regenerative cryocooler.

Other aspect of the present invention may be provide a semiconductor detecting apparatus, including:

a semiconductor detector; and

the regenerative cryocooler mentioned above;

wherein the semiconductor detector is thermally and mechanically connected to the cooling stage of the regenerative cryocooler.

Other objects, features, and advantages of the present invention will be come more apparent from the following detailed description when read in conjunction with the accompanying drawings.

### BRIEF DESCRIPTION OF THE DRAWINGS

FIG. 1 is a cross-sectional view of a related art pulse tube cryocooler;

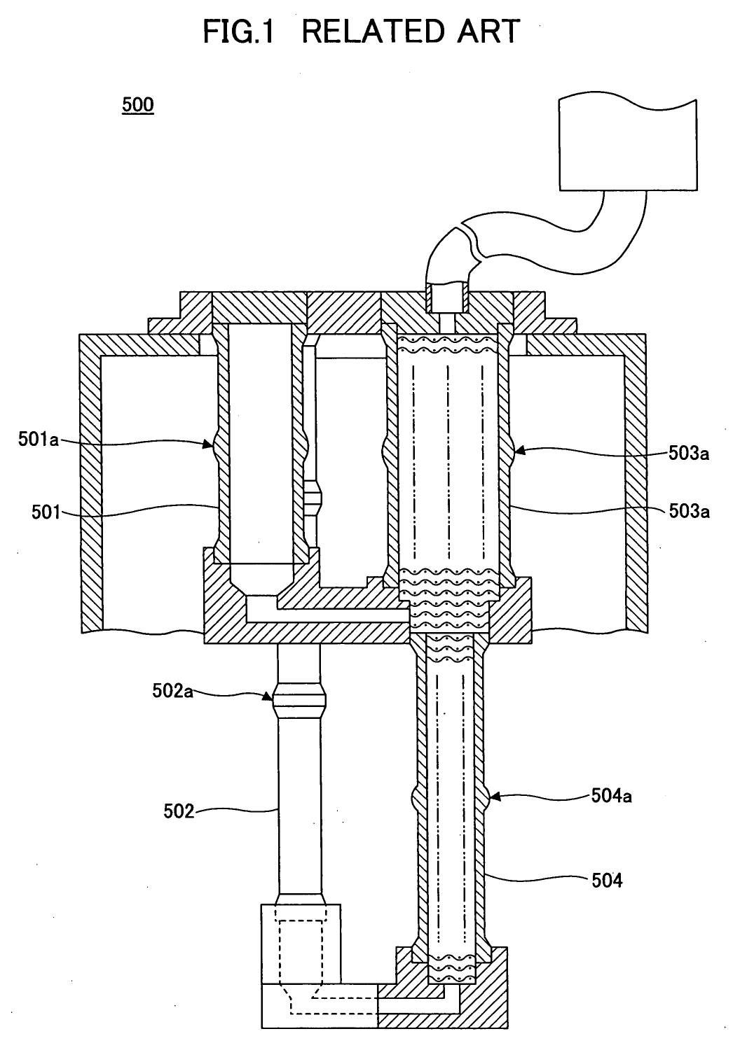

FIG. 2 is a schematic cross-sectional view of a pulse tube cryocooler of a first embodiment of the present invention;

FIG. 3 is a view for explaining operations of a cylinder of the present invention;

FIG. 4 is a schematic cross-sectional view showing a modified example of a cylinder of the pulse tube forming the pulse tube cryocooler of the first embodiment of the present invention;

FIG. 5 is a schematic cross-sectional view showing a modified example of the cylinder of a regenerator tube forming the pulse tube cryocooler of the first embodiment of the present invention;

FIG. 6 is a cross-sectional view showing cylinders of the first embodiment of the present invention and comparison examples;

FIG. 7 is a table showing properties of the first embodiment of the present invention and the comparison example;

FIG. 8 is a schematic cross-sectional view of a GM (Gifford-McMahon) cryocooler of a second embodiment of the present invention;

FIG. 9 is a schematic cross-sectional view of a Stirling cryocooler of a third embodiment of the present invention;

FIG. 10 is a schematic cross-sectional view of a cryopump of a fourth embodiment of the present invention;

FIG. 11 is a schematic cross-sectional view of a recondensing apparatus of a fifth embodiment of the present invention;

FIG. 12 is a schematic cross-sectional view of a superconducting magnet apparatus of a sixth embodiment of the present invention; and

FIG. 13 is a schematic cross-sectional view of a semiconductor detecting apparatus of a seventh embodiment of the present invention.

### DETAILED DESCRIPTION OF THE PREFERRED EMBODIMENTS

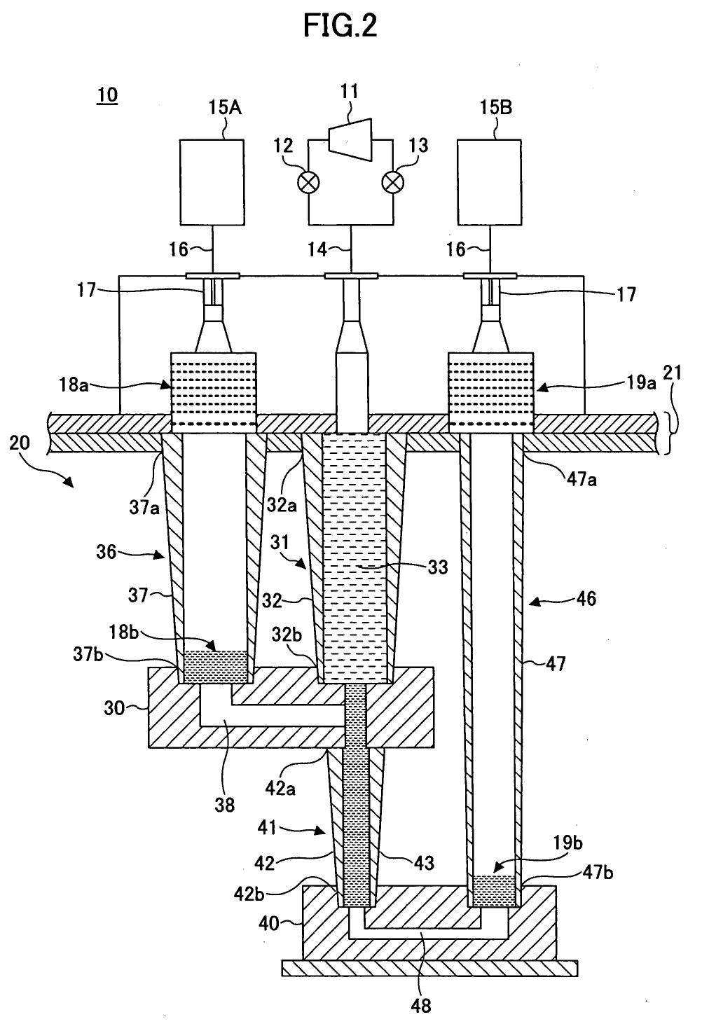

A description is given below, with reference to the FIG. 2 through FIG. 13 of embodiments of the present invention.

### First Embodiment

FIG. 2 is a schematic cross-sectional view of a pulse tube cryocooler of a first embodiment of the present invention.

Referring to FIG. 2, a pulse tube cryocooler 10 of a first embodiment of the present invention includes a gas compressor 11 and a two-stage type cold head 20. Helium gas is taken in and exhausted by the gas compressor 11 and a subject to be cooled (not shown in FIG. 20) can be cooled by the cold head 20. The cold head 20 includes a first stage regenerator tube 31, a first-stage pulse tube 36, a first stage cooling stage 30, a second stage regenerator tube 41, a second stage pulse tube 46, and a second stage cooling stage 40.

The first stage regenerator tube 31 includes a cylinder 32 made of, for example, stainless steel, and a regenerative material 33 formed by a metal mesh made of copper or stainless steel. The inside of the cylinder 32 is filled with the regenerative material 33. The first stage pulse tube 36 includes a hollow cylinder 37 made of, for example, stainless steel.

High temperature ends 32a and 37a of the cylinders 32 and 37, respectively, come in contact with and are fixed to a flange 21. Low temperature ends 32b and 37b of the cylinders 32 and 37 come in contact with and are fixed to the first stage cooling stage 30.

A gas flow path 38 is formed inside the first stage cooling stage 30. The low temperature end 37b of the first stage pulse tube 36 and the low temperature end 32b of the first stage regenerator tube 31 are connected to each other via a heat exchanger 18b and the gas flow path 38. The first stage cooling stage 30 is thermally and mechanically connected to a subject to be cooled (not shown in FIG. 2) and heat is transferred from the subject to be cooled.

The second stage regenerator tube 41 includes a cylinder 42 made of, for example, stainless steel, and a regenerative material 43 formed by a metal mesh made of copper or stainless steel. The inside of the cylinder 42 is filled with the regenerative material 43. The second stage pulse tube 46 includes a cylinder 47 made of, for example, stainless steel.

A high temperature end 42a of the cylinder 42 of the second stage regenerator tube 41 comes in contact with and is fixed to the first stage cooling stage 30. A low temperature end 42b of the cylinder 42 comes in contact with and is fixed to the second stage cooling stage 40. A high temperature end 47a of the cylinder 47 of the second stage pulse tube 46 comes in contact with and is fixed to the flange 21. A low temperature end 47b of the cylinder 47 comes in contact with and is fixed to the second stage cooling stage 40.

A gas flow path 48 is formed inside the second stage cooling stage 40. The low temperature end 47b of the second stage pulse tube 46 and the low temperature end 42b of the first stage regenerator tube 41 are connected to each other via a heat exchanger 47b and the gas flow path 48. The second stage cooling stage 40 is thermally and mechanically connected to a subject to be cooled (not shown in FIG. 2) and heat is transferred from the subject to be cooled.

In the pulse tube cryocooler 10, high pressure helium gas is supplied from the gas compressor 11 to the first stage regenerator tube 31 via a suction valve 12 and the gas flow path 14, and low pressure helium gas is supplied from the first stage regenerator tube 31 to the gas compressor 11 via the gas flow path 14 and the exhaust valve 13.

Furthermore, a first stage buffer 15A and a second stage buffer 15B are connected to the high temperature end 37a of the first stage pulse tube 36 and the high temperature end 47a of the second pulse tube 46 via the heat exchanger 18a and 19a, respectively, and orifices.

Next, operations of the pulse tube cryocooler 10 are discussed.

First, when the suction valve 12 becomes open and the exhaust valve 13 becomes closed, high pressure helium gas flows from the gas compressor 11 to the first stage regenerator tube 31. While the helium gas is cooled by the regenerative material 33 so that the temperature of the helium gas is decreased, the helium gas passes through the gas flow path from the low temperature end 32b of the first stage regenerator tube 31 and is further cooled by the heat exchanger 18b so as to flow into the first stage pulse tube 36.

Low pressure helium gas already existing inside the first stage pulse tube 36 is compressed by the flowing high pressure helium gas, so that the pressure of the low pressure helium becomes higher than that inside the buffer 15A and the low pressure helium gas passes through the orifice 17 and the gas flow path 16 and flows into the first stage buffer 15A.

A part of the high pressure helium gas cooled by the first stage regenerator tube 31 flows into the second stage regenerator tube 41. The part of the high pressure helium gas is further cooled by the regenerative material 43 so that the temperature of the part of the high pressure helium gas is decreased. The part of the high pressure helium gas passes through the gas flow path 48 from the low temperature end 42b of the second regenerator tube 41 and is further cooled by the heat exchanger 19b. The part of the high pressure helium gas flows into the second stage pulse tube 46, passes through the orifice 17 and the gas flow path 16, and flows into the second stage buffer 15B.

When the suction valve 12 becomes closed and the exhaust valve 13 becomes open, the helium gas in the first stage pulse tube 36 and the second stage pulse tube 46 pass through while the gas cools the regenerative materials 33 and 43. The helium gas passes through the exhaust valve 13 from the high temperature end 32a of the first stage regenerator tube 31 so as to return to the gas compressor 11.

The first stage pulse tube 36 and the first stage buffer 15A are connected to each other via the corresponding orifice 17. The second stage pulse tube 46 and the second stag buffer 15B are connected to each other via the corresponding orifice 17. Accordingly, a phase of pressure change and a phase of volume change of helium gas occur with a constant phase difference.

Based on this phase difference, a cooling effect due to expansion of helium gas is generated at the low temperature end 37b of the first stage pulse tube 36 and the low temperature end 47b of the second pulse tube 46. By repeating these operations, the pulse tube cryocooler 10 works as a cryocooler.

In the pulse tube cryocooler 10, the thickness of the cylinders 32, 37, 42, and 47 of the first stage regenerator tube 31, the second stage regenerator tube 41, the first stage pulse tube 36, and the second stage pulse tube 46 at the sides of high temperature ends 32a, 37a, 42a, and 47a are greater than those at the sides of low temperature ends 32b, 37b, 42b, and 47b.

More specifically, the thickness of the cylinders 32, 37, 42, and 47 of the first stage regenerator tube 31, the second stage regenerator tube 41, the first stage pulse tube 36, and the second stage pulse tube 46 is increased from the low temperature ends 32b, 37b, 42b, and 47b to the high temperature ends 32a, 37a, 42a, and 47a of the cylinders 32, 37, 42, and 47.

Because of this, it is possible to prevent heat from entering from the sides of the high temperature ends 32a, 37a, 42a, and 47a so that good cooling capacity is maintained. Rigidities of the cylinders 32, 37, 42, and 47 are higher than those of cylinders having a constant thickness from the low temperature ends 32b, 37b, 42b, and 47b. Accordingly, vibration of the first stage cooling stage 30 and the second stage cooling stage 40 at the low temperature ends due to pressure change in the cylinders based on expansion and contraction of the cylinders can be prevented.

The following discussion is made without distinction between the first stage and the second stage. In the pulse tube cryocooler 10, the low temperature ends of the pulse tube 36 and 46 and the low temperature ends of the regenerator tubes 31 and 41 may be connected to each other by a connecting tube (not shown in FIG. 2). In this case, if the cooling stages 30 and 40 are provided at either the low temperatures ends of the pulse tubes 36 and 46 or the low temperature ends of the regenerator tubes 31 and 41, a cylinder where the cooling stages 30 and 40 are not provided has a constant thickness from the low temperature end to the high temperature end.

In this case, even if vibration is generated at the cylinder having a constant thickness, almost no vibration is transmitted to the cooling stages 30 and 40. Accordingly, a subject to be cooled connected to the cooling stages 30 and 40 is not influenced. A cooling capacity can be increased by reducing the thickness.

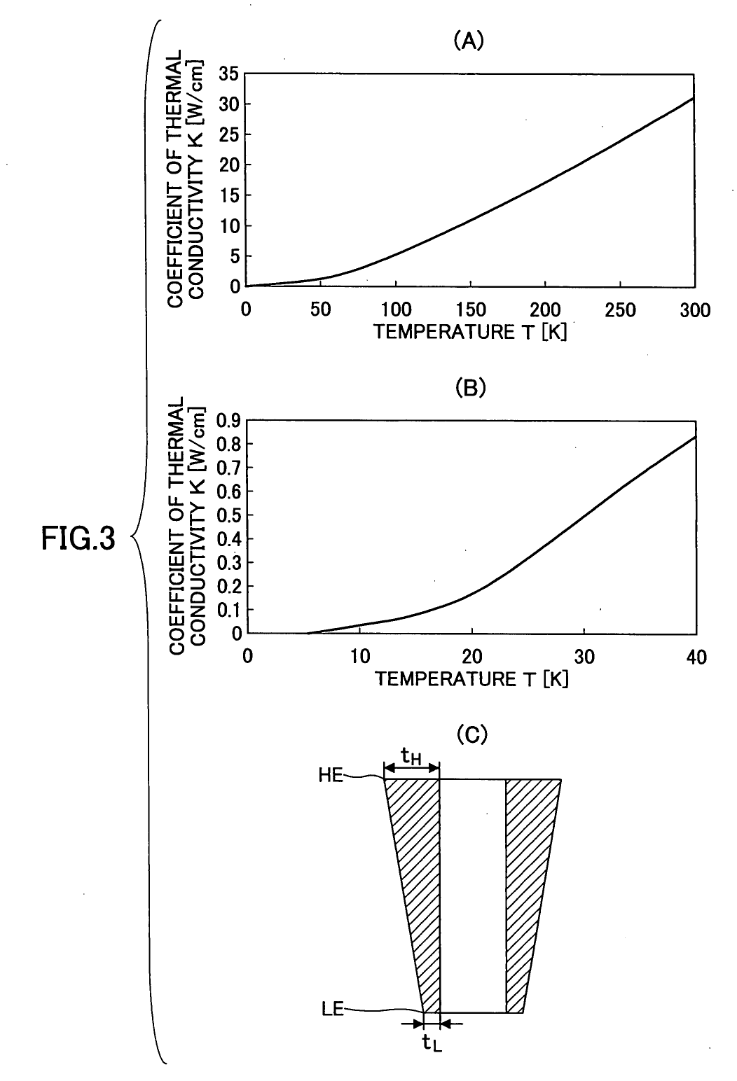

FIG. 3 is a view for explaining operations of a cylinder of the present invention. More specifically, FIG. 3(A) shows a relationship between temperature and the coefficient of thermal conductivity of stainless steel. FIG. 3(B) is an expanded view in the vicinity of temperature 20K. FIG. 3(C) is a cross-sectional view schematically showing a cylinder.

Referring to FIG. 3(A) and FIG. 3(B), the thermal conductivity is decreased from 300 K through the vicinity of 10 K. The thermal conductivity at the vicinity of 10 K is substantially zero (0). Inclination of the thermal conductivity between 300 K through 20 K is greater than the inclination of the thermal conductivity at a temperature lower than 20 K. Since thermal resistance is in inverse proportion to the thermal conductivity, the thermal resistance is increased from 300 K through the vicinity of 10 K. In addition, the thermal resistance is inversely proportional to thickness t.

As shown in FIG. 3(C), the cylinder of this embodiment has a configuration where the thickness is continuously increased from t_{L} at the low temperature end LE of the cylinder to t_{H} at the high temperature end HE of the cylinder. In other words, the cylinder of this embodiment has a configuration where the thickness is continuously decreased from t_{H} at the high temperature end HE of the cylinder to t_{L} at the low temperature end LE of the cylinder. Accordingly, the thermal resistance is drastically increased based on contribution due to the thermal conductivity of temperature gradient and contribution of the thickness.

Accordingly, by making the cylinder have the above-mentioned configuration, the thermal resistance is increased so that the amount of heat entering to the low temperature end LE is decreased. As discussed below, the amount of the conducted heat can be decreased more than the amount of conducted heat of a cylinder having a constant thickness from the low temperature end to the high temperature end.

On the other hand, amplitude by vibration at the low temperature end LE side is in inverse proportion to the coefficient of elasticity of a metal member of the cylinder and the thickness of the cylinder. For example, the coefficient of elasticity in an axial direction of the stainless steel at this temperature is constant and the thickness is continuously increased from t_{L} to t_{H}.

Therefore, it is possible to reduce the amplitude due to the vibration more than that of a case where the thickness is constant (t_{L}), by an effect of the thickness increasing. Accordingly, the cylinder of this embodiment can decrease the amount of conducted heat and vibration.

In addition, as shown in FIG. 3(B), the thermal conductivity is increased at a temperature equal to or higher than 10 K. Accordingly, it is preferable that the reaching temperature of the cylinder of the regenerator tube and the pulse tube of the pulse tube cryocooler be equal to or higher than 10 K from the viewpoint that the conducted heat is effectively decremented. This point can be applied to the GM (Gifford-McMahon) cryocooler of the second embodiment, the Stirling cryocooler of the third embodiment and a regenerative cryocooler having the cylinder.

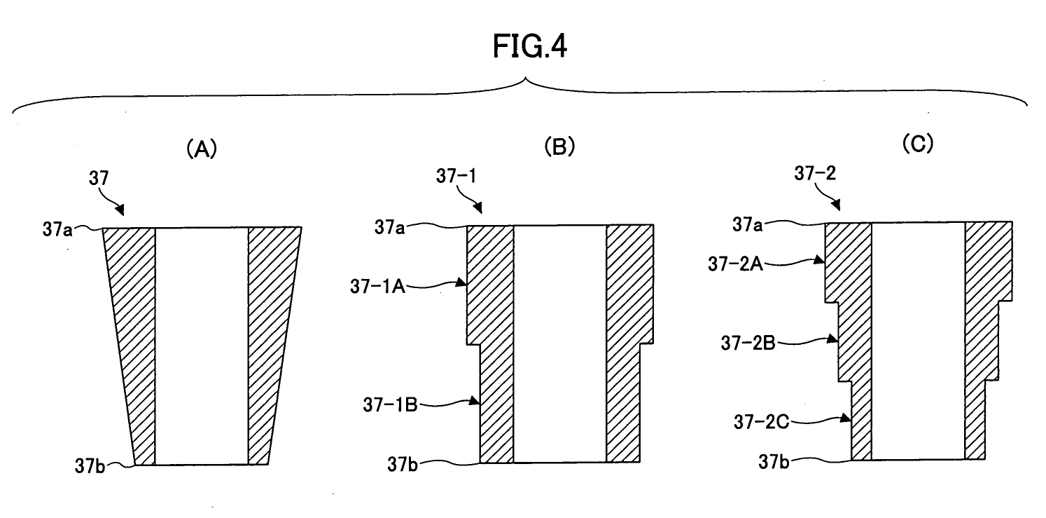

FIG. 4 is a schematic cross-sectional view showing a modified example of a cylinder of the pulse tube forming the pulse tube cryocooler of the first embodiment of the present invention.

FIG. 4(A) shows a schematic cross section of the first stage pulse tube shown in FIG. 2. Since the cross-sectional configuration of the second pulse tube is the same as that of the first stage pulse tube, illustration thereof is omitted for the convenience of explanation.

As shown in FIG. 4(A), the thickness of the cylinder 37 of the first stage pulse tube 36 is continuously increased from the low temperature end 37b to the high temperature end 37a. Because of this configuration, as discussed above, the cylinder 37 can have decreased amounts of conducted heat and vibration.

In this case, it is preferable that the reaching temperature of the low temperature end 37b of the first stage pulse tube 36 be equal to or higher than 10 K from the viewpoint that the effect of decrementing of the conducted heat is effective. For example, the thickness of the cylinder 37 at the low temperature end 37b side is in a range 0.1 mm through 1.0 mm, and the thickness of the cylinder 37 at the high temperature end 37a side is in a range 1.0 mm through 3.0 mm.

FIG. 4(B) and FIG. 4(C) show modified examples of the cylinder of the pulse tube 36. Referring to FIG. 4(B) and FIG. 4(C), the thickness of the cylinders 37-1 and 37-2 of the pulse tube 36 is increased in stages from the low temperature end 37b to the high temperature end 37a.

In the example shown in FIG. 4(B), the cylinder 37-1 has a two-stage structure of cylinder parts 37-1A and 37-1B where the thickness of the cylinder parts 37-1A and 37-1B of the pulse tube 36 is increased in a two-stage manner from the low temperature end 37b to the high temperature end 37a.

For example, the thickness of the cylinder part 37-1B at the low temperature end 37b side is in a range 0.1 mm through 1.0 mm, and the thickness of the cylinder part 37-1A at the high temperature end 37a side is in a range 1.0 mm through 3.0 mm.

Furthermore, in the example shown in FIG. 4(C), the cylinder 37-2 has a three-stage structure of cylinder parts 37-2A, 37-2B, and 37-2C where the thickness of the cylinder parts 37-2A, 37-2B, and 37-2C of the pulse tube is increased in a three-stage manner from the low temperature end 37b to the high temperature end 37a.

For example, the thickness of the cylinder part 37-2C at the low temperature end 37b side is in a range 0.1 mm through 1.0 mm, the thickness of the cylinder part 37-2B in the center is in a range 1.0 mm through 2.0 mm, and the thickness of the cylinder part 37-2A at the high temperature end 37a side is in a range 2.0 mm through 3.0 mm.

The cylinders 37-1 and 37-2 achieve the same effect as the effect achieved by the cylinder 37 shown in FIG. 4(A) and it is possible to easily manufacture the cylinders 37-1 and 37-2. In addition, as the number of stages is more than 2, it is possible to reduce the conducted heat. Considering reducing the conducted heat and the balance between process abilities and manufacturing costs, it is preferable for the number of stages to be between two (2) and five (5). Of course, the number of stages may be equal to or greater than six (6).

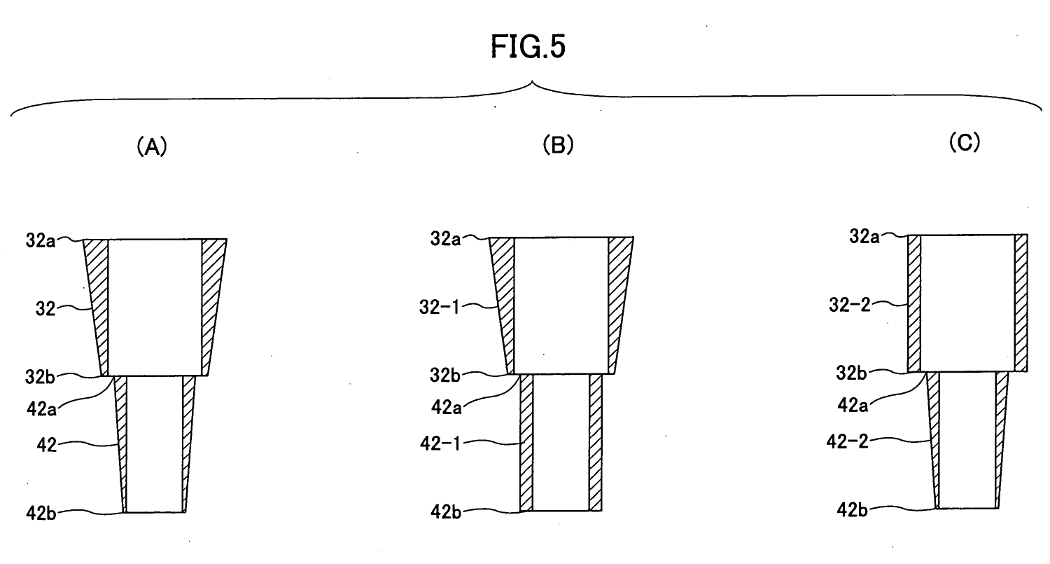

FIG. 5 is a schematic cross-sectional view showing a modified example of the cylinder of a regenerator tube forming the pulse tube cryocooler of the first embodiment of the present invention.

FIG. 5(A) shows a schematic cross section of the first stage cooling storing tube and the second stage cooling storing tube shown in FIG. 2. Illustrations of the first cooling stage, the second cooling stage, and others are omitted in FIG. 5(A) as well as FIG. 5(B) and FIG. 5(C).

As shown in FIG. 5(A), the thickness of the cylinders 32 and 42 of the first stage regenerator tube and the second regenerator tube is continuously increased from the low temperature ends 32b and 42b to the high temperature ends 32a and 42a.

In this case, it is preferable that the reaching temperature of the low temperature ends 32b and 42b be equal to or higher than 10 K from the viewpoint of the effect of decrementing the conducted heat being effective. The reaching temperature of the low temperature end 32b of the first stage regenerator tube is higher than the reaching temperature of the low temperature end 42b of the second stage regenerator tube.

FIG. 5(B) shows a modified example of the first stage regenerator tube and the second stage regenerator tube.

Referring to FIG. 5(B), the thickness of the cylinder 32-1 of the first stage regenerator tube is continuously increased from the low temperature end 32b to the high temperature end 32a. The thickness of the cylinder 42-1 of the second stage regenerator tube is constant from the low temperature end 42b to the high temperature end 42a.

In the example shown in FIG. 5(B), it is preferable that the reaching temperature of the low temperature end 32b be equal to or higher than 10 K from the viewpoint of the decrementing of the conducted heat is effective. The reaching temperature of the low temperature end 42b of the second stage regenerator tube is lower than the reaching temperature of the low temperature end 32b of the first stage regenerator tube.

FIG. 5(C) shows another modified example of the first stage regenerator tube and the second stage regenerator tube.

Referring to FIG. 5(C), the thickness of the cylinder 32-2 of the first stage regenerator tube is constant from the low temperature end 32b to the high temperature end 32a. The thickness of the cylinder 42-2 of the second stage regenerator tube is continuously increased from the low temperature ends 42b to the high temperature end 42a.

In the example shown in FIG. 5(C), it is preferable that the reaching temperature of the low temperature end 42b be equal to or higher than 10 K from the viewpoint of the decrementing of the conducted heat is effective. The reaching temperature of the low temperature end 32b of the first stage regenerator tube is higher than the reaching temperature of the low temperature end 42b of the second stage regenerator tube.

The cylinders of the first stage regenerator tube and the second stage regenerator tube may have configurations where the thickness of the cylinders is increased in stages from the low temperature ends to the high temperature ends like the cylinders 37-1 and 37-2 shown in FIG. 4(B) and FIG. 4(C), instead of configurations where the thickness of the cylinders is continuously increased from the low temperature ends to the high temperature ends. In this case, manufacturing easiness can be further improved.

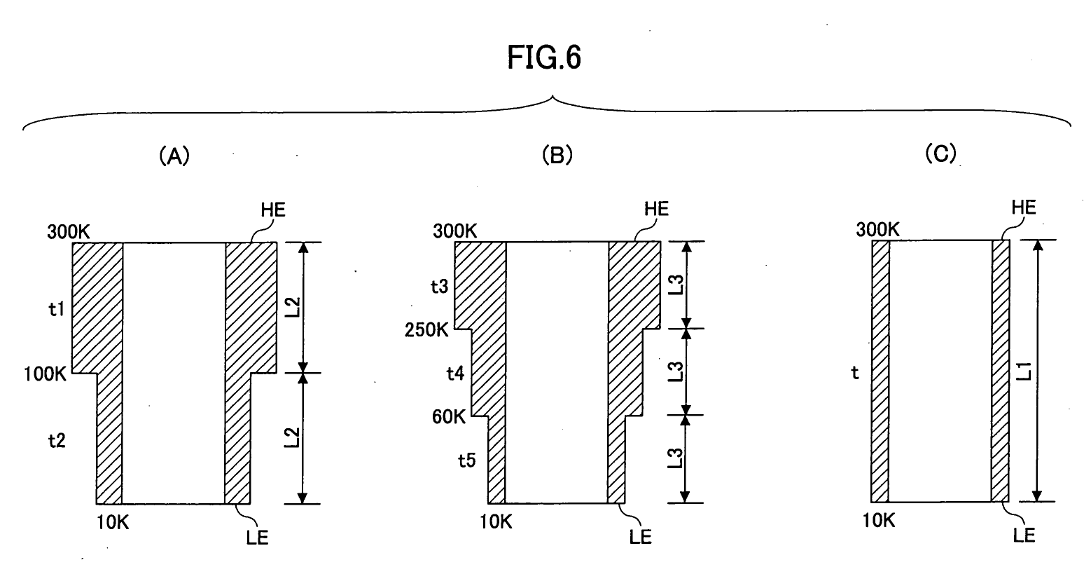

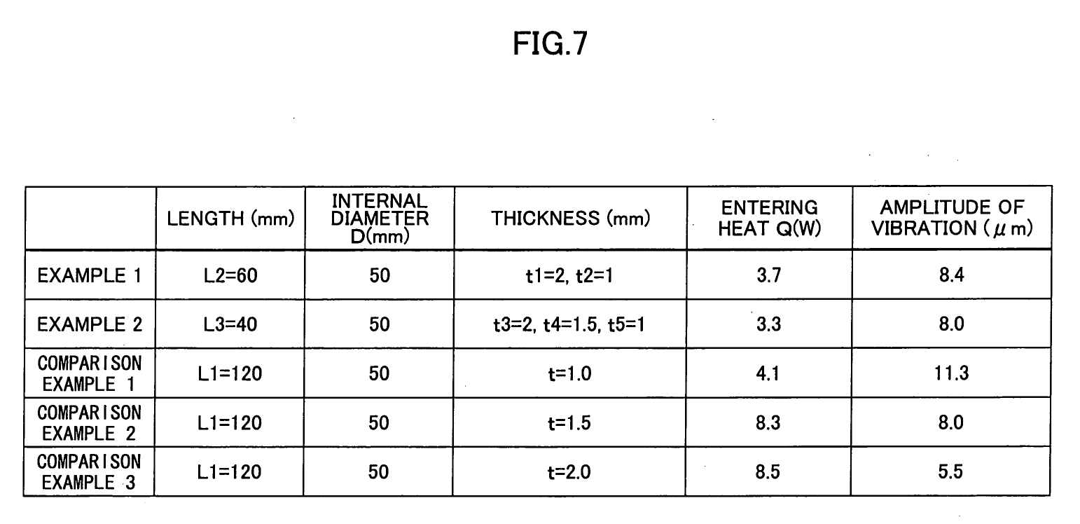

Next, examples of the embodiment of the present invention and comparison examples are discussed with reference to FIG. 6 and FIG. 7.

FIG. 6 is a cross-sectional view showing cylinders of the first embodiment of the present invention and comparison examples. More specifically, FIG. 6(A) shows an example 1, FIG. 6(B) shows an example 2, and FIG. 6(C) shows comparison examples 1 through 3.

FIG. 7 is a table showing properties and measurements of the cylinders of the first embodiment of the present invention and the comparison examples.

Referring to FIG. 6 and FIG. 7, in the cylinder of the example 1 shown in FIG. 6(A), the thickness of the cylinder part increases in a two-stage manner from the low temperature end LE to the high temperature end HE. In the cylinder of the example 1 shown in FIG. 6(B), the thickness of the cylinder part increases in a three-stage manner. On the other hand, in the cylinders of the comparison examples 1 through 3 shown in FIG. 6(C), the thickness of the cylinder parts is constant from the low temperature end LE side to the high temperature end HE side.

Measurements of the example 1, the example 2, and the comparison examples are shown in FIG. 6 and FIG. 7. The temperature of the high temperature end HE of each cylinder is 300 K and the temperature of the low temperature end LE of each cylinder is 10 K.

The average thickness in the longitudinal direction of the cylinders of the example 1 and the example 2 is 1.5 mm. The thickness of the cylinders of the comparison examples 1 through 3 is 1 mm, 1.5 mm, and 2 mm.

The temperature in a position where the thickness is different in the example 1 is 100 K. The temperature in positions where the thickness is different in the example 2 is 250 K and 60 K. These temperatures are obtained via experiments in a case where the cylinder is applied to the pulse tube and the regenerator tube (made of stainless).

In addition, the conducted heat and vibration amplitude are calculated. The conducted heat indicates an amount (W) of heat reaching the low temperature end LE. The vibration amplitude indicates peak to peak of vibration of the low temperature end LE in a case where the high temperature end HE is fixed.

As shown in FIG. 7, the vibration amplitude in the example 1 and the example 2 is substantially the same as that of the comparison example 2. The conducted heat in the example 1 is 55% or more lower than that in the comparison example 2, and the conducted heat in the example 2 is 65% or more lower than that in the comparison example 2.

In addition, the conducted heat in the examples 1 and 2 is substantially equal to or less than that in the comparison example 1. The vibration amplitudes in the examples 1 and 2 are drastically decreased compared to that in the comparison example 1.

Furthermore, the vibration amplitude in the examples 1 and 2 is greater than that in the comparison example 3 but the conducted heat in the examples 1 and 2 is less than that in the comparison example 3.

Comparing the example 1 and the example 2, the conducted heat in the three-stage cylinder is lower than that in the two-stage cylinder. The more the number of stages there are, the more the cooling capacity is improved.

The inventors of the present invention actually used the cylinders of the example 2 and the comparison example of a single stage pulse tube cryocooler. In a non-loading state, while the reaching temperature in the comparison example was 36 K, the reaching temperature of the example 2 was 32 K. Thus, it was found that the cooling capabilities in the example 2 are improved more than that in the comparison example.

In the meantime, the embodiment of the present invention is discussed above by using the orifice type pulse tube cryocooler. However, the cylinder of the embodiment of the present invention can be applied to other types of cryocooler such as a pulse tube cryocooler of a moving plug type, a check valve type, and a double inlet type.

### Second Embodiment

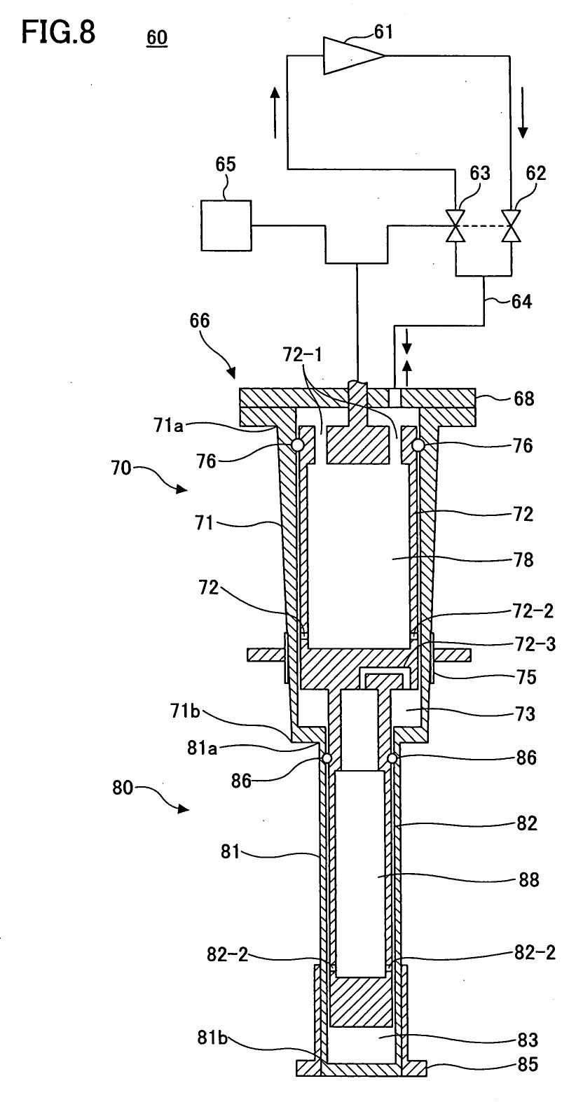

FIG. 8 is a schematic cross-sectional view of a GM (Gifford-McMahon) cryocooler of a second embodiment of the present invention.

Referring to FIG. 8, a GM (Gifford-McMahon) cryocooler 60 of the second embodiment of the present invention includes a gas compressor 61 and a two-stage type cold head 66. Helium gas is taken in and exhausted from the gas compressor 61 so that the cold head 66 works as a cryocooler. The cold head 66 includes a first stage cooling part 70 and a second stage cooling part 80. The first stage cooling part 70 and the second stage cooling part 80 coaxially connect to a flange 68.

The first stage cooling part 70 includes a first stage cylinder 71, a first stage displacer 72, a first stage regenerator 78, a first stage expansion space 73, and a first stage cooling stage 75.

The first stage displacer 72 is provided so as to reciprocate in an axial direction in the first stage cylinder 71. The first stage regenerator 78 fills in the first stage displacer 72. The volume of the first stage expansion space 73 provided inside of the low temperature end 71b changes depending on the reciprocal movement of the first stage displacer 72. The first stage cooling stage 75 is provided in the vicinity of the low temperature end 71b. A first stage seal 76 is provided between an internal wall of the first stage cylinder 71 and an external wall of the first stage displace 72.

Plural first stage high temperature side flow paths 72 are provided at the high temperature end 71a of the first stage displacer 72 so that helium gas flows in and out from the first stage regenerator 78. In addition, plural first stage low temperature side flow paths 72-2 are provided at the low temperature end 71b of the first stage displacer 72 so that helium gas flows in and out from the first stage regenerator 78 and the first stage expansion space 73.

The second stage cooling part 80 has substantially the same structure as that of the first stage cooling part 70. In other words, the second stage cooling part 80 includes a second stage cylinder 81, a second stage displacer 82, a second stage regenerator 88, a second stage expansion space 83, and a second stage cooling stage 85.

The second stage displacer 82 is provided so as to reciprocate in an axial direction in the second stage cylinder 81. The second stage regenerator 88 fills in the second stage displacer 82. The volume of the second stage expansion space 83 provided inside of the low temperature end 81b changes depending on reciprocal movement of the second stage displacer 82. The second stage cooling stage 85 is provided in the vicinity of the low temperature end 81b. A second stage seal 86 is provided between an internal wall of the second stage cylinder 81 and an external wall of the second stage displacer 82.

A second stage high temperature side flow path 72-3 is provided at the high temperature end 81a of the second stage displacer 82 so that helium gas flows in and out from the first stage regenerator 78. In addition, plural second stage low temperature side flow paths 82-2 are provided at the low temperature end 81b of the second stage displacer 82 so that helium gas flows in and out from the second stage expansion space 83.

In addition, in the GM cryocooler 60, high pressure helium gas is supplied from the gas compressor 61 to the first stage cooling part 70 and low pressure helium gas is exhausted from the first stage cooling part 70 to the gas compressor 61. A driving motor 65 make the first stage displacer 72 and the second stage displacer 82 reciprocate so that the opening and closing of a suction valve 62 and an exhaust valve 63 are connected with this and thereby timings of taking in and exhausting of the helium gas are controlled.

In the GM cryocooler 60, the temperature of the high temperature end 71a of the first stage cylinder 71 is room temperature and the temperature of the low temperature end 71b is, for example, 10 K. The temperature of the high temperature end 81a of the second stage cylinder 81 is, for example, 10 K and the temperature of the low temperature end 81b is, for example, 4K.

The high temperature end 71a of the first stage cylinder 71 is thicker than the low temperature end 71b of the first stage cylinder 71. More specifically, the thickness is continuously increased from the low temperature end 71b to the high temperature end 71a. Because of this, vibration of the first stage cooling stage 75 and the heat entering from the high temperature end 71a are prevented so that good cooling capacity is achieved.

The configuration of the first stage cylinder 71 is not limited to the configuration shown in FIG. 8. The first stage cylinder 71 may have a configuration shown in FIG. 4(B) and FIG. 4(C) where the thickness is increased in stages and the number of stages of the first stage cylinder 71 is equal to or greater than four.

The high temperature end 81a of the second stage cylinder 81 is 10 K. Therefore, the coefficient of thermal conductivity is extremely low. Hence, the thickness may be sufficient to avoid the vibration, and may be constant from the low temperature end 81b to the high temperature end 81a.

Next, operations of the GM cryocooler 60 are discussed.

First, the suction valve 62 is in a closing state and the exhaust valve 63 in an opening state. In a state where the helium gas is exhausted in the first stage cylinder 71 and the second stage cylinder 81, the first stage displacer 72 and the second stage displacer 82 are at bottom dead centers in the first stage cylinder 71 and the second stage cylinder 81, respectively.

Next, when the suction valve 62 is an opening state and the exhaust valve 63 is an opening state, high pressure helium gas flows from the gas compressor 61 to the first stage cooling part 70.

The high pressure helium gas flows from the first stage high temperature side flow path 72-1 to the first stage regenerator 78 and is cooled by the regenerative material of the first stage regenerator 78 at the designated temperature. The cooled helium gas flows from the first stage low temperature side flow path 72-2 to the first expansion space 73.

A part of the high pressure helium gas 5 flowing in the first stage expansion space 73 flows from the second stage high temperature side flow path 72-3 to the second stage cold storage device 88. The flowing helium gas is cooled at a lower designated temperature by the regenerative material of the second stage regenerator 88 and flows from the second stage low temperature side flow path 82-2 to the second stage expansion space 83.

As a result of this, the insides of the first stage expansion space 73 and the second stage expansion space 83 become high pressure states.

After that, the first stage displacer 72 and the second stage displacer 82 move to sides of top dead center and the high pressure helium gas is supplied to the first stage expansion space 73 and the second stage expansion space 83.

When the first stage displacer 72 and the second stage displacer 82 reach the top dead center, the suction valve 62 is closed.

After that, when the exhaust valve 63 is opened, the situation of the helium gas is changed from the high pressure state to the low pressure state so that the volume of the helium gas is expanded. Because of this, a cooling effect is formed in the first stage expansion space 73 and the second stage expansion space 83.

At this time, the helium gas in the first stage expansion space 73 and the helium gas in the second stage expansion space 83 are in a lower temperature and lower pressure state than the above-mentioned initial state so that the first stage cooling stage 75 and the second stage cooling stage 85 are cooled. The first stage cooling stage 75 and the second stage cooling stage 85 absorb heat from a subject to be cooled thermally connecting to the first stage cooling stage 75 and the second stage cooling stage 85 so as to be cooled.

Next, the first stage displacer 72 and the second stage displacer 82 move to the bottom dead center. Because of this, the helium gas is passed through a path reversing the above-mentioned path. While the helium gas cools the first stage displacer 72 and the second stage displacer 82, the helium gas returns from the exhaust valve to the gas compressor 61. Then, the first stage displacer 72 and the second stage displacer 82 reach the bottom dead center.

The above-discussed operations as one cycle are repeated.

Thus, although pressure inside of the first stage cylinder 71 and the second stage cylinder 81 pulse due to the reciprocating movement of the first stage displacer 72 and the second stage displacer 82, respectively, as discussed above, the thickness of the first stage cylinder 71 is continuously increased from the low temperature end 71b to the high temperature end 71a. Therefore, the rigidity of the first stage cylinder is improved so that the vibration of the first stage cylinder 71 due to change (pulse) of the pressure can be prevented.

When the temperature of the high temperature end 81a of the second stage cylinder 81 is higher than 10 K, the configuration of the second stage cylinder 81 is the same as the first stage cylinder 71. Because of this, it is possible to achieve good cooling capacity and prevention of vibration.

In the GM cryocooler 60 of this embodiment of the present invention, the vibration of the cooling stage is prevented and the heat entering from the high temperature end 71a side is prevented. Thus, the GM cryocooler 60 of this embodiment of the present invention has good cooling capacity.

### Third Embodiment

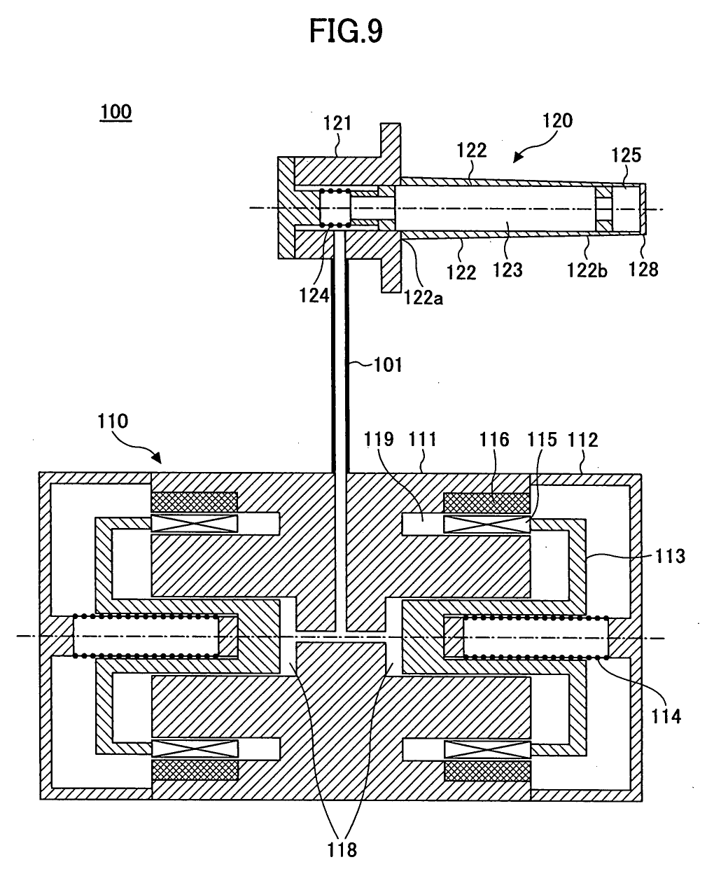

FIG. 9 is a schematic cross-sectional view of a Stirling cryocooler of a third embodiment of the present invention.

Referring to FIG. 9, the Stirling cryocooler of the third embodiment of the present invention includes a gas compressor 112 and a cold head 120. Working gas is taken in and exhausted from the gas compressor 110 via a capillary 101 so that the cold head 120 works as a cryocooler.

The gas compressor 110 includes a yoke 111, a dwelling vessel 112, and a compressing piston 113.

The yoke 11 includes a cylindrical-shaped groove forming part 118, a ring-shaped groove forming part 119, and a ring-shaped permanent magnet 116. The groove forming part 118 forms a cylinder of the compressing piston 113. A movable coil 115 fixed to the compressing piston 113 is inserted in the groove forming part 119. The permanent magnet 116 is embedded in an outside internal wall of the groove forming part 119. An outside electric power supply (not shown in FIG. 9) is connected to the movable coil 115.

The dwelling vessel 112 is fixed to the yoke 111. The compressing piston 113 is received inside the dwelling vessel 112 so that a dwelling space that helium gas fills is formed. A piston control spring 114 is configured to connect the compressing piston 113 and the dwelling vessel 112 so as to avoid the compressing piston 113 coming in contact with the internal wall of the dwelling vessel 112.

The cold head 120 includes a housing part 121 and a cylinder 122 connected to the housing part 121. The cold head 120 also includes a cooling stage 128. A displacer 123 has the cylinder 122 that the regenerative material fills. An expansion space 125 is provided at the low temperature end 122b of the cylinder 122 and the cooling stage 128 is fixed to the expansion space 125. The cold head 120 includes a displacer control spring 124 for keeping the displacer 123 at the center point.

The high temperature end 122a of the cylinder 122 is thicker than the low temperature end 122b of the cylinder 122. More specifically, the thickness is continuously increased from the low temperature end 122b to the high temperature end 122a. Because of this, vibration of the cooling stage 128 and the conducted heat from the high temperature end 122a side are prevented so that good cooling capacity is achieved.

The configuration of the cylinder 122 is not limited to the configuration shown in FIG. 9. The cylinder 122 may have a configuration shown in FIG. 4(B) and FIG. 4(C) where the thickness is increased in stages and the number of stages of the cylinder is equal to or greater than four.

The number of stages of the cylinder may be more than two and, in this case, the cylinder may have a configuration shown in FIG. 5(A) through FIG. 5(C) and the cylinder shown in FIG. 4(B) and FIG. 4(C) may be combined.

Next, operations of the Stirling cryocooler are discussed. In the Stirling cryocooler, an alternating electrical current is supplied from the external electric power supply to the movable coil and the compressing piston reciprocates in the horizontal direction of the drawing. As a result of this, a cycle of four stages, namely isothermal compression, isovolume moving, isothermal expansion, and isovolume moving of helium gas is repeated in a space of the groove forming part 119, a space of the expansion space 125, and a space connecting the spaces to the each other where gas flows, so that a cooling effect is formed.

In the Stirling cryocooler of this embodiment of the present invention, the vibration of the cooling stage 128 is prevented and the conducted heat from the high temperature end 122a side is prevented. Thus, the Stirling cryocooler of this embodiment of the present invention has good cooling capacity.

### Fourth Embodiment

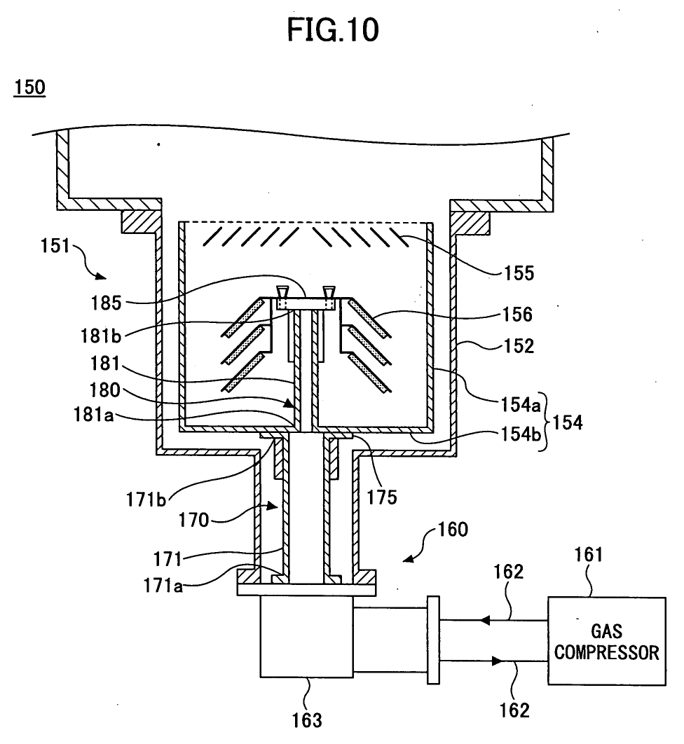

FIG. 10 is a schematic cross-sectional view of a cryopump of a fourth embodiment of the present invention.

Referring to FIG. 10, the cryopump of the fourth embodiment of the present invention includes a cryopump main body part 151 connected to a vacuum chamber to be exhausted via a suction opening.

The cryopump main body part 151 includes a vacuum chamber 152. A shield part 154, a two-stage type cryocooler 160, a baffle 155, cryopanels 156, and other are provided inside the vacuum chamber 152. Thermometers configured to measure temperatures of the shield part 154, the baffle 155, and the cryopanels 156 and a safety valve configured to take out gas when the inside pressure of the vacuum vessel increases are provided in the vacuum chamber 152.

The cryocooler 160 has substantially the same structure as that of the GM cryocooler 60 of the second embodiment of the present invention. The cryocooler 160 includes a first stage cooling part 170, a second stage cooling part 180 and a compressor 161 configured to generate compressed working fluid.

The first stage cooling part 170 and the second stage cooling part 180 include an expansion device and a regenerator (not shown in FIG. 10) configured to make adiabatic expansion of the working fluid supplied from the compressor 161 to the gas flow path 162 and perform cooling.

A first stage cooling stage 175 is provided at the head end of the first stage cooling part 170 so as to be capable of cooling at the temperature equal to or lower than 80 K. A second stage cooling stage 185 is provided at the head end of the second stage cooling part 180 so as to be capable of cooling at the temperature equal to or higher than 10 K and equal to or lower than 20 K.

An internal edge of the flange 154b of the shield part 154 is fixed to the first stage cooling stage 175. Because of this, the flange 154b thermally comes in contact with the first stage cooling stage 175 so as to cool the flange 154b and a cylindrical shape part 154a and keep temperatures of them substantially equal to the temperature of the first stage cooling stage 175.

The baffle 155 is provided at the suction opening side of the shield part 154. Upper and lower ends of the baffle 155 are opened and the inside of the baffle 155 is formed by hollow pyramidal-shaped members. The baffle 155 is composed of plural pyramidal-shaped members having different internal diameters. In addition, the baffle 155 thermally comes in contact with the shield part 154 by a beam member (not shown) or the like.

Since the shield part 154 thermally comes in contact with the first stage cooling stage 175, a cooling effect of the first stage cooling stage is transmitted to the baffle 155 so that the baffle 155 is cooled at, for example, approximately 80 K. The baffle 155 controls the direction of the gas flowing inside the cryopump main body 151 so as to cool the gas. The baffle 155 condenses vapor contained in the gas so as to reduce heat radiation to the cryopanel 156.

A top part of the cryopanel 156 is fixed on the second stage cooling stage 185. Plural metal plates formed at the top parts and cylindrical parts extending from the top part downward in umbrella shapes are separately provided. Since the top part of the cryopanel 156 thermally comes in contact with the second stage cooling stage 25, the temperature of the cryopanel 156 is kept at a temperature substantially the same as that of the second stage cooling stage 185.

An adhesion panel is formed on a rear surface of the cryopanel 156. The adhesion panel adheres an adhesive such as activated carbon by an epoxy resin having a good thermal conductivity. The adhesion panel adheres hydrogen, neon, helium or the like not condensed by the cryopanel 156. A part where the adhesion panel is formed is not limited to the rear surface of the cryopanel 156.

The high temperature ends 171a and 181a of the cylinders 171 and 181 are thicker than the low temperature ends 171b and 181b of the cylinders 171 and 181. More specifically, the thickness is continuously increased from the low temperature ends 171b and 181b to the high temperature ends 171a and 181a. Because of this, vibration of the first stage cooling stage 175 and the second stage cooling stage 185 and the heat entering from the high temperature end 171a side are prevented so that good cooling capacity is achieved.

Since the vibration of the cryopanel 156 is prevented and the cryopanel 156 is sufficiently cooled, exhaust capacities are improved. The configurations of the cylinders 171 and 181 may be those shown in FIG. 4(B) and FIG. 4(C) or FIG. 5(A) and FIG. 5(B).

As the cryocooler 160, instead of the GM cryocooler, a two-stage type cryocooler of the pulse tube cryocooler of the first embodiment of the present invention and the Stirling cryocooler of the third embodiment of the present invention may be used.

### Fifth Embodiment

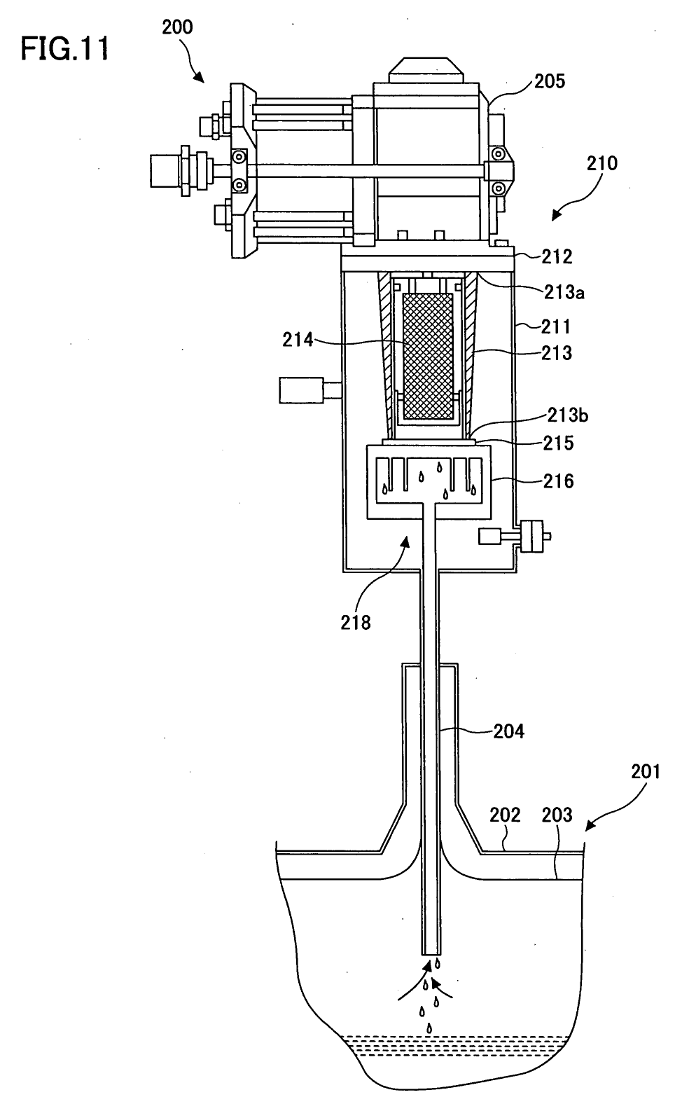

FIG. 11 is a schematic cross-sectional view of a recondensing apparatus of a fifth embodiment of the present invention.

Referring to FIG. 11, a recondensing apparatus 200 of the fifth embodiment of the present invention is configured to recondense nitrogen gas made by vaporizing liquid nitrogen in a liquid nitrogen vessel 203 provided in a vacuum vessel 202. The liquid nitrogen vessel 203 works as a thermal shield of a liquid helium vessel that liquid helium for cooling a superconducting magnet fills.

The recondensing apparatus 200 includes a cryocooler 210, a vacuum vessel 211, a recondensing device 216, and an adiabatic moving tube 204.

The cryocooler 210 can cool the subject at a liquid nitrogen temperature. The vacuum vessel 211 is configured to hold a cooling stage 215 of the cryocooler 210 in a vacuum state. The recondensing device 216 is provided at the cooling stage 215 and is configured to condense the nitrogen gas to liquid nitrogen. The adiabatic moving tube 204 communicates between inside of the recondensing device 216 and inside of the liquid nitrogen vessel 203. In FIG. 11, the illustration of a gas compressor configured to compress helium gas as the working gas of the cryocooler is omitted.

The cryocooler 210 is a one-stage type GM cryocooler shown in FIG. 8 of the second embodiment of the present invention. Since the cryocooler 210 has substantially the same structure and operations as those of the GM cryocooler of the second embodiment of the present invention, detailed explanation thereof is omitted. The cryocooler 210 includes a cylinder 213 fixed to a flange 212 and a displacer 214 provided in the cylinder 213. The displacer 214 is driven by a driving motor 205 so as to reciprocate and thereby a cooling effect is formed at the low temperature end 213b.

By this cooling effect, the recondensing device 216 is cooled via the cooling stage 215 at a temperature lower than liquid nitrogen temperature. As a result of this, the nitrogen gas vaporized in the liquid nitrogen vessel 203 is cooled by the recondensing device 216 so as to be condensed to the liquid nitrogen. The nitrogen gas passes through the adiabatic moving tube 204 so as to return to the liquid nitrogen vessel 203.

In the cryocooler 210, the high temperature end 213a of the cylinder 213 is thicker than the low temperature end 213b of the cylinder 213. More specifically, the thickness is continuously increased from the low temperature end 213b to the high temperature end 213a. Because of this, vibration of the cooling stage 215 and heat conducted heat from the high temperature end 213a side are prevented so that good cooling capacity is achieved.

Because of this, it is possible to prevent a bad influence due to vibration to an MRI apparatus 201 as a connected subject to be cooled via the adiabatic moving tube 204 connected to the cooling stage 215. In addition, it is possible, by good cooling capacity, to prevent an increase of cooling costs due to discharge of the liquid nitrogen to an air and bad influence to the atmosphere in a room where the MRI apparatus 201 is provided.

The cryocooler 210 may use a one-stage pulse tube cryocooler or the Stirling cryocooler, instead of the GM cryocooler. In addition, the cryocooler 210 has plural stages and a reaching temperature of the second, the third, or more stage cooling stage may be 4 K so that the liquid helium can be recondensed.

In addition, the recondensing apparatus can be applied as a recondensing apparatus of a liquid nitrogen vessel or a liquid helium vessel provided in an SQUID (superconducting quantum interference device), an SCM (superconducting magnet) device, or an EDX (energy-dispersive X-ray) analyzing device, in addition to the MRI apparatus 201.

### Sixth Embodiment

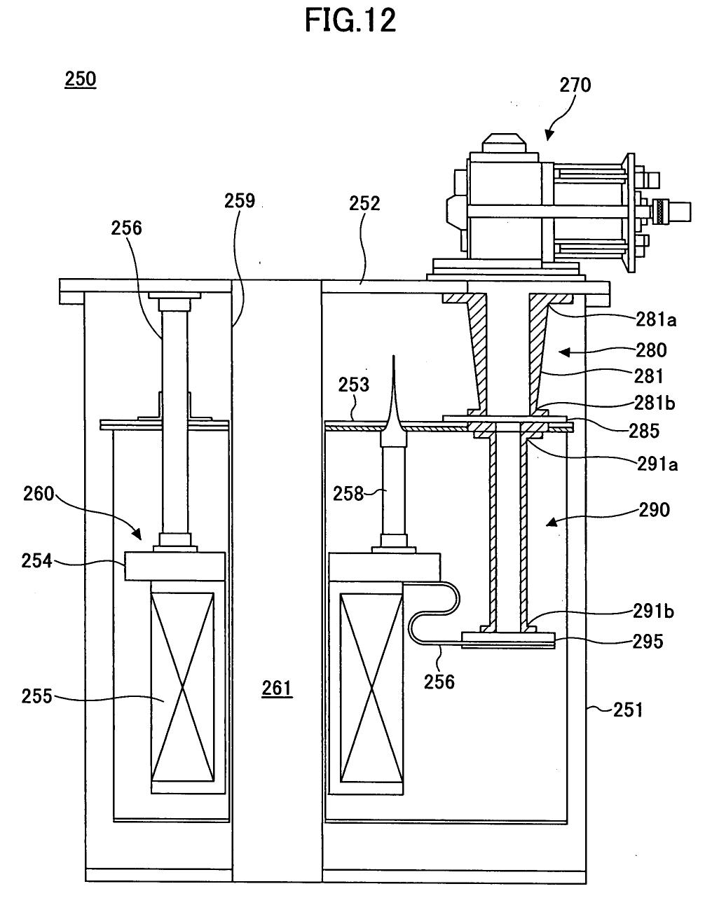

FIG. 12 is a schematic cross-sectional view of a superconducting magnet apparatus of a fourth embodiment of the present invention.

Referring to FIG. 12, a superconducting magnet apparatus 250 of the sixth embodiment of the present invention includes a vacuum vessel 251, a cryocooler 270, and a superconducting magnet 260. The cryocooler 270 has a structure where a cold head is attached at a ceiling plate 252. The superconducting magnet 260 applies a magnetic field to a high magnetic field space 261.

The cryocooler 270 is a two-stage GM cryocooler and has the same structure as that of the GM cryocooler shown in FIG. 8 of the second embodiment of the present invention. Illustration of detailed structure of the first stage and second stage cylinder is omitted.

The first stage cooling stage 285 of the cryocooler 270 is thermally and mechanically connected to an oxide superconductive electric current lead 258 configured to supply an electric current to a superconductive coil 255 of the superconductive magnet 260, by a thermal shield plate 253.

The second stage cooling stage 295 of the cryocooler 270 is thermally and mechanically connected to a coil cooling stage 254 of the superconducting coil 255. The coil cooling stage 254 comes in contact with the superconducting coil 255 so that the superconducting coil 255 is cooled to a temperature equal to or less than a superconducting critical temperature by a cold stage from the second stage cooling stage 295.

In the cryocooler 270, the high temperature ends 281a and 291a of the cylinders 281 and 291 are thicker than the low temperature ends 281b and 291b of the cylinders 281 and 291, respectively. More specifically, the thickness is continuously increased from the low temperature ends 281b and 291b to the high temperature ends 281a and 291a. Because of this, vibration of the first stage cooling stage 285 and the second stage cooling stage 295 and the heat entering from the high temperature end 281a are prevented so that good cooling capacity is achieved.

Because of this, the vibration of the superconducting magnet 260 and change of the magnetic field generated by the superconductive coil 255 are prevented and a stable and desirable magnetic field can be applied to the subject. In addition, because of good cooling capacity, it is possible to stably maintain the superconductive state of the superconductive coil 255 and the oxide superconductive electrical current lead 258. The configurations of the cylinders 281 and 291 may be those shown in FIG. 4(B), FIG, 4(C), FIG. 5(A), or FIG. 5(B).

In addition, the cryocooler 270 may use the pulse tube cryocooler of the first embodiment of the present invention or a two-stage of the Stirling cryocooler of the third embodiment of the present invention, instead of the GM cryocooler.

### Seventh Embodiment

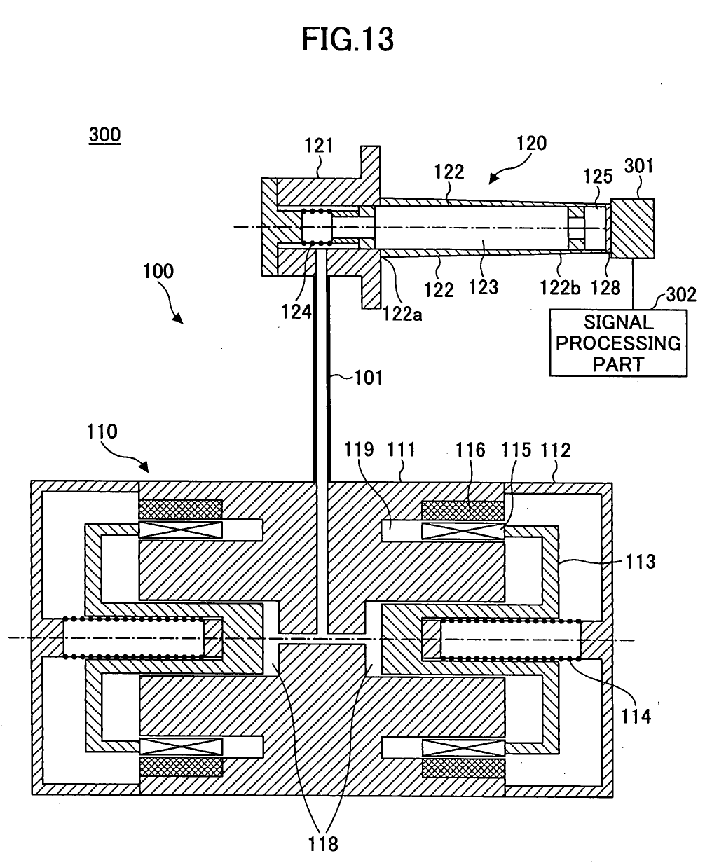

FIG. 13 is a schematic cross-sectional view of a semiconductor detecting apparatus of a seventh embodiment of the present invention. In FIG. 13, parts that are the same as the parts already discussed above are given the same reference numerals, and explanation thereof is omitted.

Referring to FIG. 13, the semiconductor detecting apparatus of the seventh embodiment of the present invention includes a cryocooler 100, a semiconductor detector 301, and a signal processing part 302. The semiconductor detector 301 comes in contact with and is fixed to the cooling stage 128 of the cryocooler. The signal processing part 302 is configured to process signals from the semiconductor detector 301.

Since the cryocooler 100 has substantially the same structure as that of the Stirling cryocooler shown in FIG. 9 of the third embodiment of the present invention, a detailed explanation thereof is omitted.

The semiconductor detector 301 includes, for example, a semiconductor radiation detecting element such as an Si detecting element or Ge detecting element, or a semiconductor infrared ray detecting element such as an InGaAs PIN photo diode. These detecting elements are cooled by a cooling effect formed by the cryocooler 100 so that noise is reduced and the signal-to-noise ratio is improved. The signal processing part 302 can use a known signal processing circuit and is properly selected based on kinds of the semiconductor detectors 301.

In the cryocooler 100, the vibration of the cooling stage 128 is prevented and good cooling capacity can be obtained. Because of this, it is possible to prevent noise generated at the semiconductor detector 301 due to the vibration such as a micro-phonic noise in the case of the semiconductor radiation detecting element. Furthermore, since the cryocooler 100 has good cooling capacity, it is possible to obtain a good signal-to noise ratio and reduce the cooling time when cooling is started at the room temperature.

Thus, according to the above-discussed embodiments, it is possible to provide a cylinder used for a cold head of a regenerative cryocooler, the cylinder including an inside having a hollow-shaped configuration for a regenerative material, wherein the thickness of the cylinder at a high temperature end side is greater than the thickness of the cylinder at a low temperature end.

The attained temperature at the low temperature end may be substantially equal to or greater than 10 K. The thickness of the cylinder may be increased in stages from the low temperature end to the high temperature end. The thickness of the cylinder may be continuously increased from the low temperature end to the high temperature end. The cylinder may be a single-stage type and the attained temperature at the low temperature end of the cylinder may be substantially equal to or greater than 10K. The cylinder may be a multiple-stage type cylinder formed by a plurality of cylinder parts; and the thickness at the high temperature end side of one of the cylinder parts may be greater than the thickness at the low temperature end side of the one of the cylinder parts; and the attained temperature at the low temperature end of the cylinder part may be substantially equal to or greater than 10K.

According to the above-mentioned cylinder, since rigidity of the cylinder is increased while entry of heat from the high temperature end of the cylinder is prevented, it is possible to prevent the vibration at the low temperature end of the cylinder. Hence, it is possible to prevent influence due to vibration to the cylinder or the cooling stage connected to the low temperature end of the cylinder.

It is also possible to provide a regenerative cryocooler, including: a working gas compressor; a cold head configured to intake and exhaust a working gas; wherein the regenerative cryocooler is a pulse tube cryocooler including a regenerator tube having a regenerative material; a hollow pulse tube where the low temperature end of the regenerator tube is connected; and a cooling stage coming in contact with the low temperature end of the regenerator tube or the pulse tube; and at least one of the regenerator tube and the pulse tube includes a cylinder mentioned above.

It is also possible to provide a regenerative cryocooler, including: a working gas compressor; a cold head configured to intake and exhaust a working gas; wherein the regenerative cryocooler is a GM (Gifford-McMahon) type cryocooler including a cylinder; a displacer installed in the cylinder; a regenerative material filling in the displacer; a cooling stage coming in contact with the low temperature end of the cylinder; and the cylinder is the cylinder mentioned above.

It is also possible to provide a regenerative cryocooler, including: a working gas compressor; a cold head configured to intake and exhaust a working gas; wherein the regenerative cryocooler is a Stirling cryocooler including a cylinder; a displacer installed in the cylinder; a regenerative material filling in the displacer; a cooling stage coming in contact with the low temperature end of the cylinder; and the cylinder is the cylinder mentioned above.

According to the above-mentioned regenerative cryocooler, since good freezing capabilities are obtained and vibration to the cylinder is prevented, it is possible to stably cool a subject to be cooled connected to the cooling stage. In addition, it is possible to prevent a bad influence causing mechanical fatigue or signal degradation due to the vibration on the subject to be cooled.

It is also possible to provide a cryopump, including: a cryopanel configured to condense a gas molecule; and the regenerative cryocooler mentioned above; wherein the cryopanel is thermally and mechanically connected to the cooling stage of the regenerative cryocooler.

It is also possible to provide a recondensing apparatus, including: a recondensing device configured to condense gas to liquid; and the regenerative cryocooler mentioned above; wherein the recondensing device is thermally and mechanically connected to the cooling stage of the regenerative cryocooler.

It is also possible to provide a superconducting magnet apparatus, including: a superconducting magnet; and the regenerative cryocooler mentioned above; wherein the superconducting magnet is thermally and mechanically connected to the cooling stage of the regenerative cryocooler.

It is also possible to provide a semiconductor detecting apparatus, including: a semiconductor detector; and the regenerative cryocooler mentioned above; wherein the semiconductor detector is thermally and mechanically connected to the cooling stage of the regenerative cryocooler.

According to the above-mentioned cryopump, recondensing apparatus, superconducting magnet apparatus, and semiconductor detecting apparatus, a subject to be cooled is thermally and mechanically connected to the cooling stage having cooling capacity and where vibration is prevented. Therefore, it is possible to stably cool a subject to be cooled and prevent bad influence causing a mechanical fatigue or signal degradation due to the vibration on the subject to be cooled.

Thus, according to the embodiments of the present invention, it is possible to provide a regenerative cryocooler, a cylinder such as a regenerator tube or a pulse tube used for the regenerative cryocooler, and, a cryopump, a recondensing apparatus, a superconducting magnet apparatus, and a semiconductor detecting apparatus using the regenerative cryocooler, whereby both good cooling capabilities and prevention of vibration can be achieved.

Although the invention has been described with respect to specific embodiment for a complete and clear disclosure, the appended claims are not to be thus limited but are to be construed as embodying all modifications and alternative constructions that may occur to one skilled in the art that fairly fall within the basic teaching herein set forth.

For example, examples where the cylinder of the embodiment of the present invention is applied to the pulse tube cryocooler, the GM (Gifford-McMahon) cryocooler, and the Stirling cryocooler are discussed in the first through third embodiments of the present invention. However, the cylinder of the embodiment of the present invention may be applied to other regenerative cryocoolers.

In addition, examples where the pulse tube cryocooler, the GM (Gifford-McMahon) cryocooler, and the Stirling cryocooler of the first through third embodiments of the present invention are applied to applied apparatuses are discussed in the fourth through seventh embodiments of the present invention. However, the pulse tube cryocooler, the GM (Gifford-McMahon) cryocooler, and the Stirling cryocooler of the first through third embodiments of the present invention may be applied to other applied apparatuses.

This patent application is based on Japanese Priority Patent Application No. 2006-237928 filed on Sep. 1, 2006, the entire contents of which are hereby incorporated by reference.

What is claimed is:

1. A cylinder used for a cold head of a regenerative cryocooler, the cylinder comprising:
an inside having a hollow-shaped configuration for a regenerative material,
wherein the thickness of the cylinder at a high temperature end is greater than the thickness of the cylinder at a low temperature end.

2. The cylinder as claimed in claim 1,
wherein the attained temperature at the low temperature end is substantially equal to or greater than 10 K.

3. The cylinder as claimed in claim 1,
wherein the thickness of the cylinder is increased in stages from the low temperature end to the high temperature end.

4. The cylinder as claimed in claim 1,
wherein the thickness of the cylinder is continuously increased from the low temperature end to the high temperature end.

5. The cylinder as claimed in claim 1,
wherein the cylinder is a single-stage type and the attained temperature at the low temperature end of the cylinder is substantially equal to or greater than 10K.

6. The cylinder as claimed in claim 1,
wherein the cylinder is a multiple-stage type cylinder formed by a plurality of cylinder parts; and
the thickness at the high temperature end side of one of the cylinder parts is greater than the thickness at the low temperature end side of the one of the cylinder parts; and
the attained temperature at the low temperature end of the cylinder part is substantially equal to or greater than 10K.

7. A regenerative cryocooler, comprising:
a working gas compressor;
a cold head configured to intake and exhaust a working gas;
wherein the regenerative cryocooler is a pulse tube cryocooler including
a regenerator tube having a regenerative material;
a pulse tube where the low temperature end of the regenerator tube is connected; and
a cooling stage coming in contact with the low temperature end of the regenerator tube or the pulse tube; and
at least one of the regenerator tube and the pulse tube includes the cylinder as claimed in claim 1.

8. A regenerative cryocooler, comprising:
a working gas compressor;
a cold head configured to intake and exhaust a working gas;
wherein the regenerative cryocooler is a GM (Gifford-McMahon) type cryocooler including
a cylinder;
a displacer installed in the cylinder;
a regenerative material filling in the displacer;
a cooling stage coming in contact with the low temperature end of the cylinder; and
the cylinder is the cylinder claimed in claim 1.

9. A regenerative cryocooler, comprising:
a working gas compressor;
a cold head configured to intake and exhaust a working gas;
wherein the regenerative cryocooler is a Stirling cryocooler including
a cylinder;
a displacer installed in the cylinder;
a regenerative material filling in the displacer;
a cooling stage coming in contact with the low temperature end of the cylinder; and
the cylinder is the cylinder claimed in claim 1.

10. A cryopump, comprising:
a cryopanel configured to condense a gas molecule; and
the regenerative cryocooler claimed in claim 7;
wherein the cryopanel is thermally and mechanically connected to the cooling stage of the regenerative cryocooler.

11. A recondensing apparatus, comprising:
a recondensing device configured to condense gas to liquid; and
the regenerative cryocooler claimed in claim 7;
wherein the recondensing device is thermally and mechanically connected to the cooling stage of the regenerative cryocooler.

12. A superconducting magnet apparatus, comprising:
a superconducting magnet; and
the regenerative cryocooler claimed in claim 7;
wherein the superconducting magnet is thermally and mechanically connected to the cooling stage of the regenerative cryocooler.

13. A semiconductor detecting apparatus, comprising:
a semiconductor detector; and
the regenerative cryocooler claimed in claim 7;
wherein the semiconductor detector is thermally and mechanically connected to the cooling stage of the regenerative cryocooler.
